(19) United States
(12) Patent Application Publication
(10) Pub. No.: US 2015/0283427 A1
(43) Pub. Date: Oct. 8, 2015

(54) MOTION ANALYSIS SYSTEM AND MOTION ANALYSIS METHOD

(71) Applicant: SEIKO EPSON CORPORATION, Tokyo (JP)

(72) Inventor: Kazuhiro Shibuya, Shiojiri-shi (JP)

(21) Appl. No.: 14/437,209

(22) PCT Filed: Dec. 11, 2013
(86) PCT No.: PCT/JP2013/007282

§ 371 Date: Apr. 21, 2015

(30) Foreign Application Priority Data
Dec. 18, 2012 (JP) 2012-275994

(51) Int. Cl. A63B 24/00; G06K 9/00

(52) U.S. Cl. CPC A63B 24/0003; G06K 9/00342

(57) ABSTRACT

A motion analysis system includes an analysis control device that receives measurement data of physical quantities based on a motion of a measurement subject from a plurality of measuring units, calculates, for each of the measuring units, a first calculation value based on the physical quantities, determines, as timing of an impact in the motion, time when a value based on the first calculation value satisfies a predetermined condition, synchronizes, on the basis of the timing of the impact, the measurement data generated by the plurality of measuring units, and analyzes the motion of the measurement subject.

### TECHNICAL FIELD

The present invention relates to a motion analysis system, a motion analysis method, and the like.

### BACKGROUND ART

Systems for analyzing motions are required in various fields. For example, athlete abilities can be improved by analyzing, for example, swing tracks of a golf club and a tennis racket and motion forms of pitching and batting of baseball and the like and clarifying points of improvement from analysis results.

As a motion analysis system, optical motion capture has been conventionally known. This is a system for continuously photographing, with an infrared camera or the like, a target attached with a marker and calculating a moving track of the marker using photographed continuous images to analyze a motion (PTL 1).

On the other hand, in recent years, there has been proposed a method of attaching a small inertial sensor to a test subject and analyzing a motion of the test subject from output data of the sensor (PTL 2). This method has an advantage that handling is easy because an infrared camera is unnecessary.

### CITATION LIST

### Patent Literature

PTL 1: JP-A-2010-110382

PTL 2: JP-A-2008-073210

### SUMMARY OF INVENTION

### Technical Problem

In the invention of PTL 2, first and second gyro sensors are respectively fixed to a head section and a grip section of a golf club. Therefore, a control section configured to control the gyro sensors and a storing section configured to store data from the gyro sensors can be provided in the golf club and connected by wire. In this case, a main control section can acquire both of data from the first gyro sensor and data from the second gyro sensor substantially on a real time basis and record the data.

That is, in the invention of PTL 2, it is possible to associate the data from the first and second gyro sensors without causing temporal deviation. A problem of impossibility of synchronization between the two data hardly occurs. “Synchronizing” means associating data from a plurality of sensors with one another on one time axis.

However, for example, when a plurality of sensors used for measurement are arranged apart from one another or when data temporarily stored in buffers in the sensors are collectively received, a data receiving side needs to synchronize the data of the plurality of sensors.

A motion analysis system in which a plurality of sensors used for measurement are arranged apart from one another and data is acquired by radio is examined. In this case, in the method described in PTL 2, data of the plurality of sensors are synchronized on the basis of elapsed times after switches change to an ON state. However, in such a system, the switches of the sensors are changed to the ON state in order using radio. Therefore, times until the switches change to the ON state are different in the respective sensors. Therefore, in the method described in PTL 2, the data from the plurality of sensors cannot be synchronized.

For a motion analysis system, it is preferable that a degree of freedom of arrangement of a plurality of sensors used for measurement is high. However, if data from different sensors cannot be correctly synchronized, a motion analysis cannot be correctly performed.

In terms of costs, it is desirable not to increase components of the motion analysis system. In terms of convenience of use of the motion analysis system, it is desirable not to request a user of the motion analysis system to perform a special action or the like.

### Solution to Problem

An advantage of some aspects of the invention is to provide a motion analysis system, a measuring unit, and a motion analysis method with which it is possible to perform an accurate motion analysis by synchronizing measurement data while increasing a degree of freedom of an attaching position of the measuring unit for measuring a physical quantity based on a motion, costs do not increase, and convenience of use is high. The motion analysis means, for example, analyzing the position, the speed, the acceleration, and the like of a specific part due to a motion of a measurement subject.

The invention can be implemented as the following forms or application examples.

### Application Example 1

A motion analysis system according to this application example includes a plurality of measuring units; and a analysis control device, wherein the analysis control device receives measurement data of physical quantities based on a motion of a measurement subject from each of the plurality of measuring units, determines, for each of the measuring units, timing of an impact in the motion using the measurement data, and synchronizes the measurement data using the timing of the impact.

### Application Example 2

The motion analysis system according to the application example described above may be configured such that the measuring unit includes an angular velocity sensor for detecting angular velocities generated around a plurality of axes, and the motion analysis system calculates, as a first calculation value, a sum of magnitudes of the angular velocities generated in the axes and determines the timing of the impact using the first calculation value.

### Application Example 3

The motion analysis system according to the application example described above may be configured such that the motion analysis system determines, as the timing of the impact, timing when the first calculation value is the maximum.

The motion analysis system according to this application example includes a measuring unit and an analysis control device. The measuring unit is attached to a measurement subject and includes a sensor section. The sensor section measures a predetermined physical quantity based on a motion of the measurement subject and generates measurement data. The sensor section may be a physical quantity sensor such as an acceleration sensor, an angular velocity sensor, or a speed sensor. For example, the sensor section may be an inertial sensor and include an acceleration sensor and an angular velocity sensor.

The motion analysis system according to this application example includes a plurality of the measuring units. A plurality of measurement data are generated and output to the analysis control device. The analysis control device, which receives the measurement data, determines timing of an impact caused by the motion of the measurement subject in the measurement data and synchronizes the plurality of measurement data. The impact means a shock due to a collision between the measurement subject and an object or a person other than the measurement subject. For example, when a golf club or a hand holding the golf club is the measurement subject, a shock in hitting a golf ball is the impact.

The analysis control device calculates a first calculation value based on the measured predetermined physical quantity and determines, as the timing of the impact in the motion, time when the first calculation value or a value based on the first calculation value satisfies a predetermined condition.

The sensor section may include an angular velocity sensor with two or more axes. In this case, the predetermined physical quantity may be angular velocity and the first calculation value may be a sum (a norm) of magnitudes of angular velocities around the axes. The analysis control device may determine, as the timing of the impact, time when the norm is the maximum. Since the norm suddenly changes at an instance of an impact, the analysis control device can accurately learn the timing of the impact because the sensor section includes the angular velocity sensor and can synchronize a plurality of measurement data. Therefore, it is possible to execute an accurate motion analysis for the measurement subject.

The measuring unit may include, for example, an angular velocity sensor or an acceleration sensor for single axis detection. The analysis control device can calculate a maximum of the measurement data as the first calculation value and learn the timing of the impact and can synchronize the plurality of measurement data.

The measuring unit may be separated from the analysis control device in a range in which the analysis control device can receive the measurement data. Therefore, it is possible to increase a degree of freedom of an attaching position of the measuring unit. It is possible to perform an accurate motion analysis by synchronizing the measurement data. However, in this case, since a special signal or the like for synchronizing the measurement data is not used, costs of the motion analysis system do not increase. In the motion analysis system according to this application example, since a user does not need to perform a special action, it is possible to provide the motion analysis system having high convenience of use.

Note that, when the timing of the impact is determined, not only the first calculation value (e.g., the norm) but also a value based on the first calculation value (e.g., a differential value or an integral value of the norm) may be used. The predetermined condition is not limited to the condition that the first calculation value is the maximum. For example, minimum, maximal, or minimal may be used.

The sensor section may be a sensor that can measure a plurality of kinds of physical quantities. For example, the sensor section may be a six-axis inertial sensor and may be able to measure accelerations and angular velocities concerning respective x axis, y axis, and z axis.

The measurement data generated by the measuring unit may be discrete data. That is, the measurement data may be generated by sampling the continuous data output from the sensor section at a predetermined sampling cycle (e.g., 0.001 second).

### Application Example 4

The motion analysis system according to the application example described above may be configured such that the analysis control device differentiates the first calculation value to calculate a second calculation value and detects, as the timing of the impact, earlier timing of timing when the second calculation value is the maximum and timing when the second calculation value is the minimum.

When the sensor section includes an angular velocity sensor with two or more axes, the analysis control device may calculate a second calculation value obtained by differentiating the first calculation value, which is the sum of the magnitudes of the angular velocities around the axes. The analysis control device may detect, as the timing of the impact, earlier timing of timing when the second calculation value is the maximum and timing when the second calculation value is the minimum.

In a normal swing action, at the time of an impact, angular velocity suddenly changes because of a shock of the impact. Therefore, it is possible to grasp, as the timing of the impact, timing when a differential value of a sum (a nouns) of magnitudes of angular velocities in a series of swing actions is the maximum or the minimum.

Note that, since an instrument used for a swing is vibrated by the impact, timing when the differential value of the sum (the norm) of the magnitudes of the angular velocities is the maximum and timing when the differential value is the minimum are considered to occur as a pair. However, earlier timing of the timings is considered to be an instance of the impact.

### Application Example 5

The motion analysis system according to the application example described above may be configured such that the measuring unit includes an acceleration sensor for detecting accelerations generated in a plurality of axial directions and the motion analysis system calculates, as a first calculation value, a sum of the magnitudes of the accelerations generated in the axes.

When the sensor section includes an acceleration sensor with two or more axes, the analysis control device may calculate, as the first calculation value, a sum of the magnitudes of the accelerations generated in the axes. At the time of an impact, a change occurs in acceleration in the measurement subject (e.g., a golf club) because of a shock of the impact. Therefore, the analysis control device may determine timing of the impact on the basis of the sum of the magnitudes of the accelerations.

### Application Example 6

The motion analysis system according to the application example described above may be configured such that the analysis control device differentiates the first calculation value to calculate a second calculation value and determines, as the timing of the impact, time when the second calculation value is the maximal for the first time.

According to this application example, irrespective of whether the sensor section includes the angular velocity sensor or includes the acceleration sensor, the analysis control device differentiates the sum (the first calculation value) of the magnitudes of the angular velocities or the accelerations generated in the axes to calculate the second calculation value. The analysis control device may determine, as the timing of the impact, time when the second calculation value is the maximal for the first time.

At an instance of the impact, a physical quantity measured by the sensor section greatly changes before and after the impact. Therefore, in order to learn a change amount, it is possible to differential the first value to calculate the second value and determine, as the timing of the impact, a first maximal value of the second calculation value.

### Application Example 7

A motion analysis method according to this application example includes receiving measurement data of physical quantities based on a motion of a measurement subject from each of a plurality of measuring units, determining, as timing of an impact in the motion, time when the measurement data satisfies a determination condition, and synchronizing the measurement data using the timing of the impact.

### BRIEF DESCRIPTION OF DRAWINGS

FIG. 1 is a diagram showing a configuration example of a motion analysis system in an embodiment.

FIG. 2 is a diagram showing an example in which a golf swing is measured by the motion analysis system in the embodiment.

FIG. 3 is a diagram showing an example of a measured track of a golf club (an exercise instrument).

FIG. 4 is a block diagram of a measuring unit shown in FIG. 1.

FIG. 5 is a block diagram of an analysis control device shown in FIG. 1.

FIG. 6 is a diagram for explaining the operations of components of the motion analysis system in the embodiment.

FIGS. 7(A) and FIG. 7(B) are diagrams showing examples of measurement data.

FIG. 8 is a flowchart for explaining processing of a measuring unit of the motion analysis system in the embodiment.

FIG. 9 is a flowchart for explaining processing by the analysis control device of the motion analysis system in the embodiment.

FIG. 10 is a flowchart for explaining processing of a rhythm detecting step in FIG. 9.

FIG. 11A is a diagram in which three-axis angular velocities during a full swing are represented as a graph.

FIG. 11B is a diagram in which a calculation value of a sum (a norm) of the magnitudes of the three-axis angular velocities is represented as a graph.

FIG. 11C is a diagram in which a calculation value of differential of a sum (a norm) of the magnitudes of the three-axis angular velocities is represented as a graph.

FIG. 12A is a diagram in which three-axis angular velocities during putting are represented as a graph.

FIG. 12B is a diagram in which a calculation value of a sum (a norm) of the magnitudes of the three-axis angular velocities is represented as a graph.

FIG. 12C is a diagram in which a calculation value of differential of a sum (a noun) of the magnitudes of the three-axis angular velocities is represented as a graph.

FIG. 13A is a diagram showing impact timing in data of the three-axis angular velocities.

FIG. 13B is a diagram showing impact timing in data of the three-axis angular velocities.

FIG. 14A is a diagram showing impact timing in data of three-axis accelerations.

FIG. 14B is a diagram showing impact timing in data of three-axis accelerations.

FIG. 15 is a diagram showing a configuration example of a motion analysis system in a comparative example.

### DESCRIPTION OF EMBODIMENTS

A preferred embodiment of the invention is explained in detail below with reference to the drawings. Note that the embodiment explained below does not unduly limit contents of the invention described in the appended claims. All components explained below are not always essential components of the invention.

### 1. Configuration of a Motion Analysis System

Main Configuration of this Embodiment

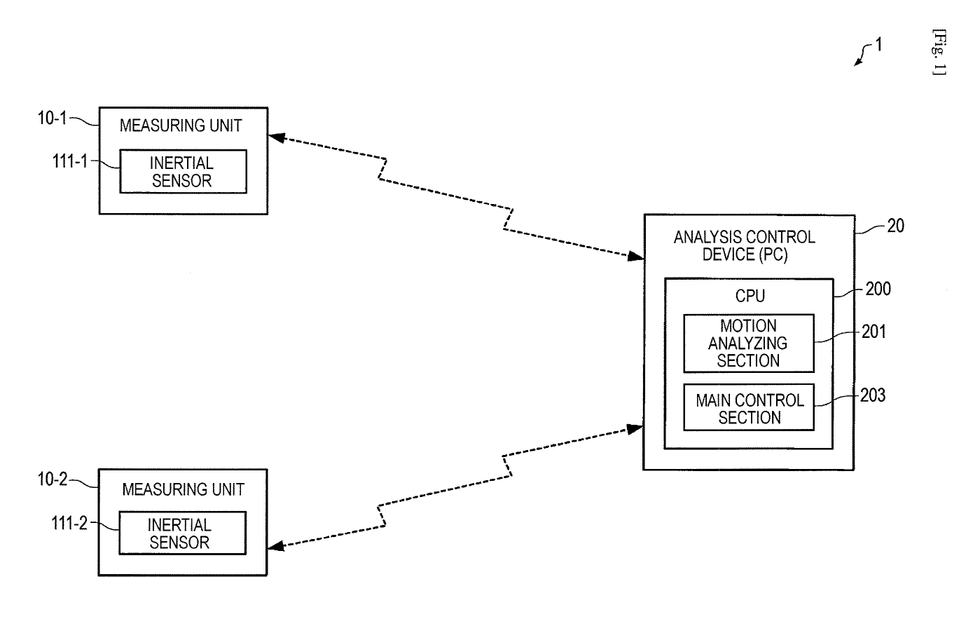

FIG. 1 is a diagram showing a configuration example of a motion analysis system 1 in this embodiment. The motion analysis system 1 includes a plurality of measuring units 10-1 and 10-2 and an analysis control device 20.

The motion analysis system 1 includes the two measuring units 10-1 and 10-2. However, the motion analysis system 1 may include three or more measuring units. In this embodiment, the analysis control device 20 and the measuring units 10-1 and 10-2 are connected by radio. A degree of freedom of arrangement of the measuring units 10-1 and 10-2 in the motion analysis system 1 is high. Between the analysis control device 20 and the measuring units 10-1 and 10-2, multicast and broadcast are not performed in order to suppress band consumption and communication is performed by unicast. Measurement data is transmitted from the measuring units 10-1 and 10-2 to the analysis control device 20 by radio. A control signal for a measurement start instruction or the like is transmitted from the analysis control device 20 to the measuring units 10-1 and 10-2.

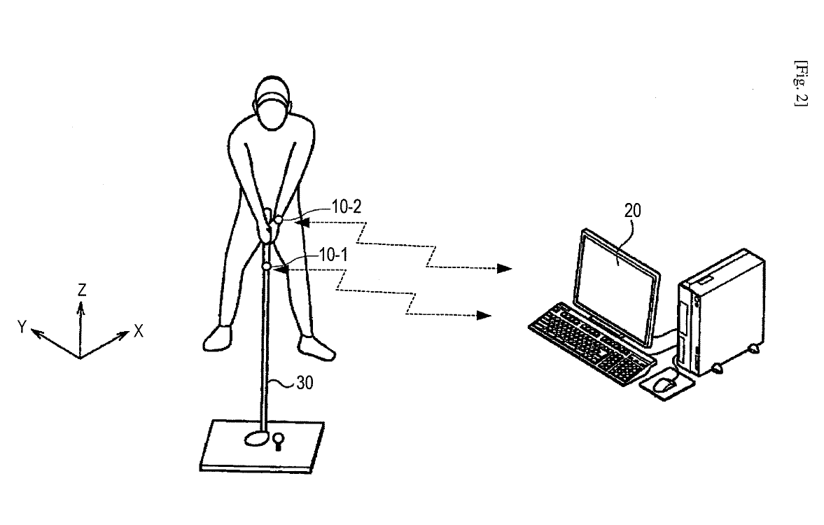

The measuring units 10-1 and 10-2 are attached to a target of a motion analysis (hereinafter, a measurement subject). The measurement subject is at least one of a user of the motion analysis system 1 and an exercise instrument (e.g., a golf club or a tennis racket). The motion analysis system 1 can be applied to analyses of various kinds of exercises. However, in this embodiment, the motion analysis system 1 is used for an analysis of a golf swing (see FIG. 2).

The measuring units 10-1 and 10-2 respectively include inertial sensors 111-1 and 111-2 (corresponding to the sensor section according to the invention). The inertial sensors 111-1 and 112-2 measure acceleration and angular velocity (corresponding to the predetermined physical quantity according to the invention) caused by the user performing a golf swing and generate measurement data.

The analysis control device 20 includes a motion analyzing section 201 configured to execute a motion analysis for the measurement subject and a main control section 203 configured to perform control of not only the analysis control device 20 but also the entire motion analysis system 1. In this embodiment, the analysis control device 20 is realized by a PC (Personal Computer). A CPU 200 functions as the motion analyzing section 201 and the main control section 203 according to a program.

The motion analyzing section 201 of the analysis control device 20 can synchronize a plurality of measurement data by receiving measurement data from the measuring units 10-2 and 10-2 and detecting timing of an impact in the measurement data. Therefore, it is possible to accurately analyze the motion of the measurement subject.

In this case, an impact used for synchronization is naturally generated by the motion of the measurement subject. The motion analysis system 1 does not need a signal or the like exclusive for synchronizing measurement data (hereinafter, exclusive information for synchronization). Note that the impact means a shock due to a collision between the measurement subject and an object or a person other than the measurement subject. In this example, the golf club is also the measurement subject. A shock in hitting a golf ball is the impact.

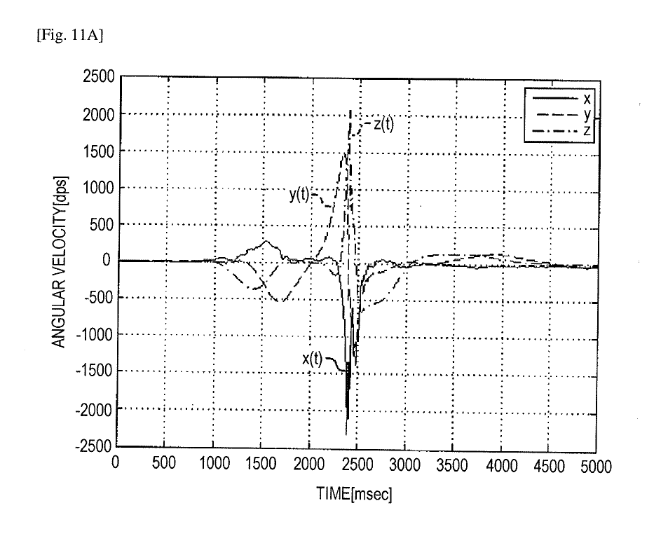

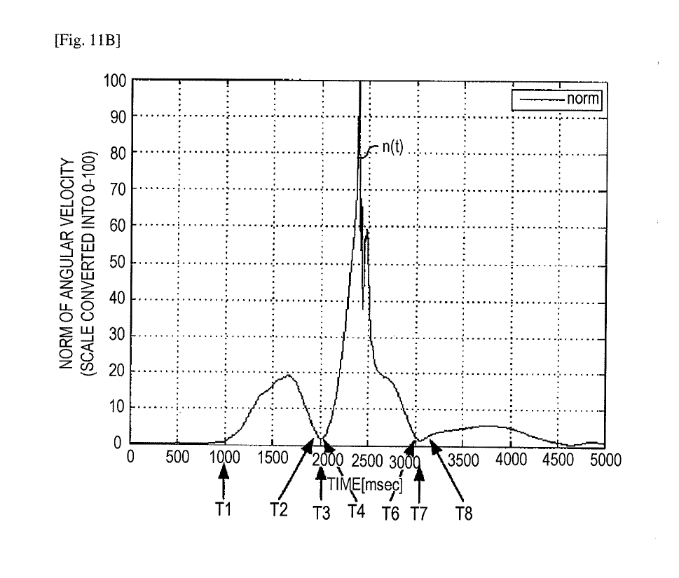

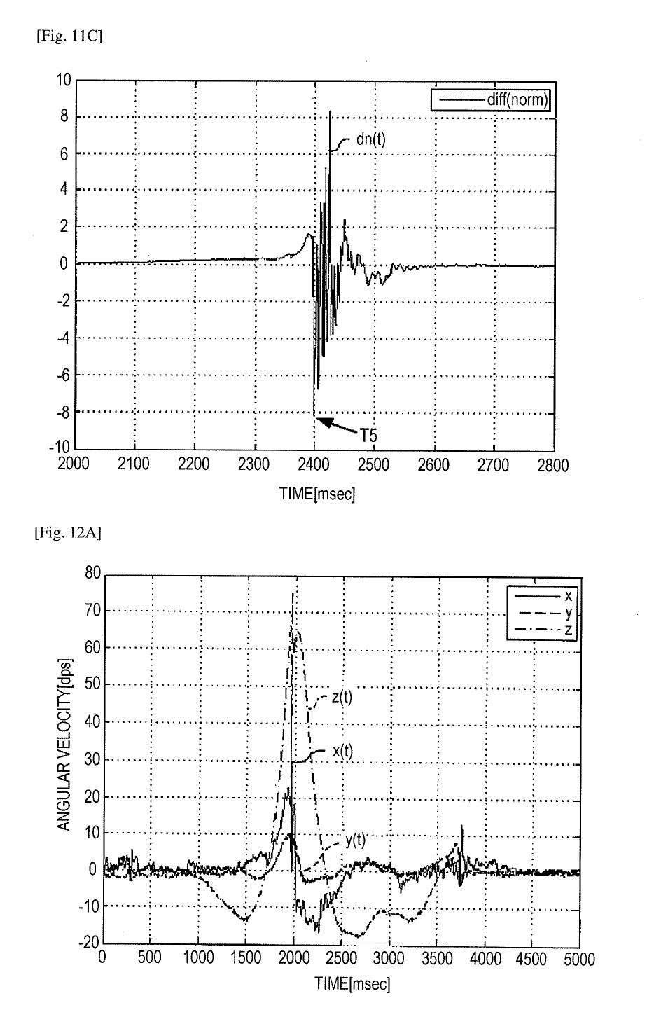

For comparison, a motion analysis system 100 having the exclusive information for synchronization is illustrated. FIG. 11.5 is a diagram showing the configuration of the motion analysis system 100 in a comparative example. The motion analysis system 100 in the comparative example uses light in a specific wavelength band as the exclusive information for synchronization. The motion analysis system 100 in the comparative example includes a light emitting device 90. The measuring sections 10-1 and 10-2 include light receiving sections 114-1 and 114-2.

In the motion analysis system 100 in the comparative example, the light emitting device 90 emits light to the measuring units 10-1 and 10-2 according to a light emission instruction from the analysis control device 20. The light receiving sections 114-1 and 114-2 detect the light emitted from the light emitting device 90, generate detection data representing presence or absence of detection, and include the detection data in the measurement data. The analysis control device 20 of the motion analysis system 100 in the comparative example synchronizes the measurement data on the basis of the detection data. Note that the same components as the components shown in FIG. 1 are denoted by the same reference numerals and signs. Therefore, explanation of the components is omitted.

When compared with the motion analysis system 100 in the comparative example, the motion analysis system 1 in this embodiment does not include the light emitting device 90. The measuring units 10-1 and 10-2 do not include the light receiving sections 114-1 and 114-2. Therefore, since a peculiar information generating section for synchronization such as the light emitting device 90 is unnecessary in the motion analysis system 1 in this embodiment, it is possible to suppress costs. Since a peculiar information detecting section for synchronization such as the light receiving sections 114-1 and 114-2 is unnecessary in the motion analysis system 1 in this embodiment, it is possible to reduce the size and the weight of a measuring unit 10.

Instead of using light in a specific wavelength band as in the comparative example, it is conceivable to use, as the exclusive information for synchronization, acceleration and angular velocity generated by a movement different from a special action, that is, a swing. As the special action, for example, it is conceivable that the user jumps. A shock by the jump generates acceleration and angular velocity completely different from a shock of the swing.

However, this is troublesome for the user because the user needs to perform an action unrelated to the swing. That is, it is desirable in terms of convenience of use of the motion analysis system 1 not to request the user to perform a special action or the like. The motion analysis system 1 in this embodiment synchronizes measurement data on the basis of timing of an impact naturally caused by a golf swing. Therefore, it is possible to realize the motion analysis system 1 having high convenience of use.

The overview of the configuration of the motion analysis system 1 is explained with reference to FIG. 1. However, a detailed block diagram of the measuring units 10-1 and 10-2 and the analysis control device 20 is explained below. The configurations of the measuring units 10-1 and 10-2 are the same. “−1” and “−2” included in the reference signs are added to individually distinguish the plurality of measuring units 10 and do not mean that the configurations are different. In the following explanation, to avoid redundant explanation, the measuring units 10-1 and 10-2 are sometimes explained as a measuring unit 10 without any particular prior notice. The inertial sensors 111-1 and 111-2 are also explained as an inertial sensor 111.

In the motion analysis system 1 in this embodiment, the analysis control device 20 is realized by a PC. However, the analysis control device 20 may be configured by dedicated hardware. In this case, at least one of the motion analyzing section 201 and the main control section 203 may be configured by dedicated hardware rather than the CPU 200.

FIG. 2 is a diagram showing the case in which a golf swing is measured by the motion analysis system 1. The user holds and swings a golf club 30. In this case, the measuring unit 10-1 is attached to the golf club 30. The measuring unit 10-2 is attached to the wrist of the user. The measuring units 10-1 and 10-2 respectively measure accelerations and angular velocities by a golf swing at the golf club 30 and the wrist of the user.

The measuring unit 10 includes a three-axis (x axis, y axis, and z axis) acceleration, sensor and a three-axis (x axis, y axis, and z axis) angular velocity sensor. The acceleration sensors respectively measure accelerations in the x-axis, y-axis, and z-axis directions and output measured acceleration data. The angular velocity sensors respectively measure angular velocities around the x axis, the y axis, and the z axis and output measured angular velocity data.

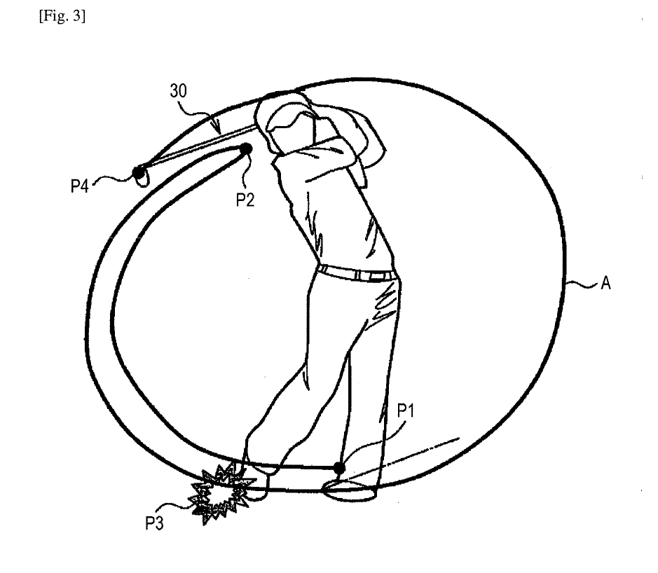

In FIG. 3, a swing track A of a club head of the golf club 30 is shown. The swing track A includes a swing start position P1, a top position P2, an impact position P3, and a follow-through top position P4. The motion analysis system 1 provides information useful for improvement by not only displaying such a swing track A but also analyzing how the user moves the wrist with respect to the swing track A.

For example, when the golf club 30 moves in the same manner as the wrist lagging behind the movement of the wrist and draws the sting track A, it can be determined that a force from the user is appropriately transmitted to the golf club 30. On the other hand, when a track of the movement of the wrist and the swing track A are different, it can be determined that, for example, the golf club 30 shifts to the front and the back and the force from the user is not straightly transmitted to the golf club 30.

In order to correctly perform such determination, the motion analysis system 1 needs to synchronize measurement data. That is, since the measuring units 10-1 and 10-2 are respectively attached to the golf club 30 and the wrist of the user, an accurate analysis cannot be performed unless measurement data from the measuring units 10-1 and 10-2 are not synchronized. As explained below, the motion analysis system 1 can accurately determine timing of an impact caused by a golf swing. Therefore, the motion analysis system 1 can synchronize a plurality of measurement data by adjusting timings of impacts of the measurement data to each other. In the following explanation, first, the detailed configurations of the measuring unit 10 and the analysis control device 20 are explained and then a method of synchronizing measurement data is explained.

Configuration of the Measuring Unit

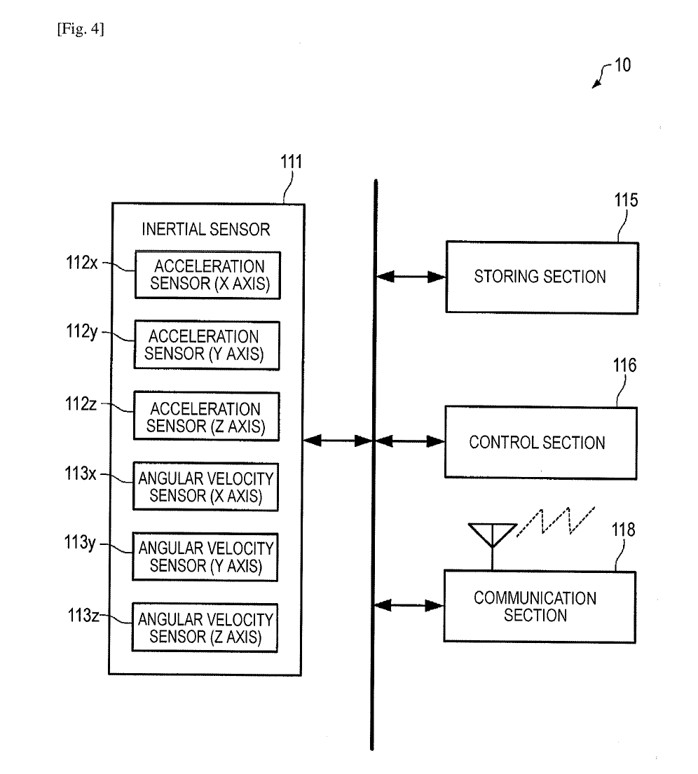

FIG. 4 is a block diagram of the measuring unit 10. The measuring unit 10 includes a storing section 115, a control section 116, and a communication section 118 besides the inertial sensor 111 shown in FIG. 1. However, the measuring unit 10 may be configured to omit or change a part of the components (the sections) shown in FIG. 4 or add other components.

The inertial sensor 111 includes the three-axis acceleration sensor and the three-axis angular velocity sensor as explained above. Therefore, more specifically, the inertial sensor 111 includes acceleration sensors 112x, 112y, and 112z and angular velocity sensors 113x, 113y, and 113z.

The control section 116 causes the storing section 115 to store, in order, measurement data from the inertial sensor 111 sampled at a predetermined cycle. Note that the predetermined cycle may be set based on, for example, a response frequency of the inertial sensor 111 and may be 1000 Hz or 500 Hz.

The control section 116 receives a control signal from the analysis control device 20 via the communication section 118. For example, if a measurement start instruction from the analysis control device 20 is received, the control section 116 actuates the inertial sensor 111 and starts storage of the measurement data in the storing section 115. For example, if a measurement stop instruction from the analysis control device 20 is received, the control section 116 stops the storage of the measurement data in the storing section 115 and transmits the measurement data stored in the storing section 115 to the analysis control device 20 via the communication section 118. The control section 116 may be a CPU.

The measuring unit 10 is connected to the analysis control device 20 by radio in the motion analysis system 1. A degree of freedom of arrangement of the measuring unit 10 is high. For example, the measuring unit 10 can be attached to the exercise instrument or can be attached to a part of the body of the user (see FIG. 2).

Configuration of the Analysis Control Device

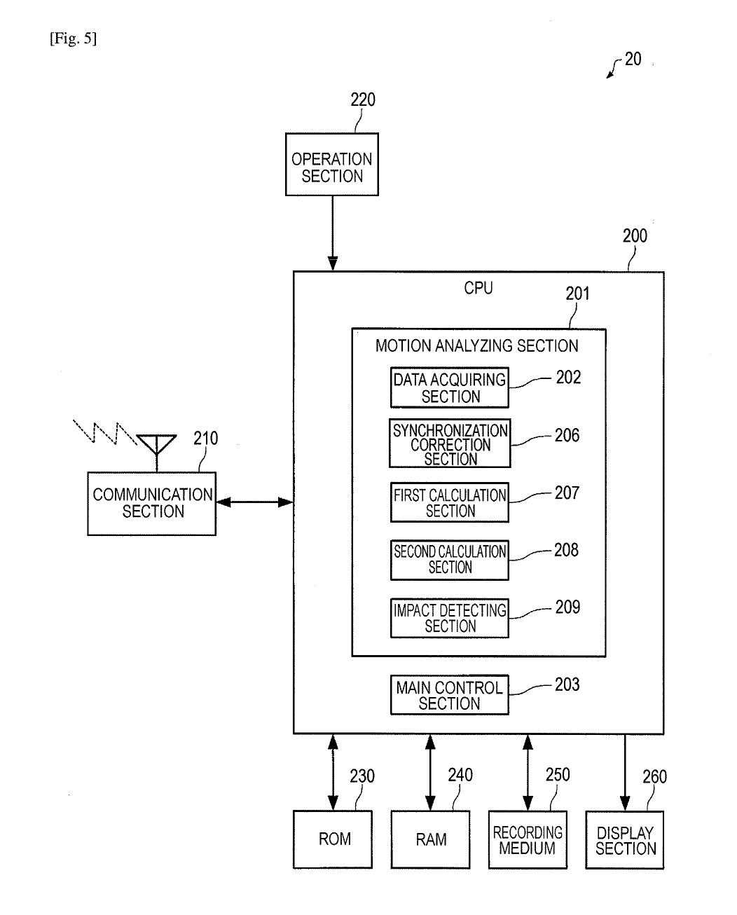

FIG. 5 is a block diagram of the analysis control device 20. The analysis control device 20 includes a communication section 210, an operation section 220, a ROM 230, a RAM 240, a recording medium 250, and a display section 260 besides the motion analyzing section 201 and the main control section 203 shown in FIG. 1. As explained with reference to FIG. 1, the CPU 200 functions as the motion analyzing section 201 and the main control section 203. The motion analyzing section 201 further includes a data acquiring section 202, a synchronization correction section 206, a first calculation section 207, a second calculation section 208, and an impact detecting section 209. However, the analysis control device 20 may be configured by omitting or changing a part of the components (the sections) shown in FIG. 5 or adding other components.

The communication section 210 performs processing for receiving measurement data from the plurality of measuring units 10-1 and 10-2 (see FIG. 1) and transmitting the measurement data to the motion analyzing section 201. The communication section 210 transmits a control signal (e.g., a measurement start instruction) from the main control section 203 to the measuring units 10-1 and 10-2.

The operation section 220 performs processing for acquiring operation data from the user and sending the operation data to the motion analyzing section 201 and the main control section 203. The operation data is, for example, data for instructing a target of a motion analysis and designating content displayed on the display section 260. The user can cause, according to operation data, the analysis control device 20 to execute the motion analysis, for example, only concerning the top position P2 to the follow-through top position P4 and display the speed of the club head in the impact position P3 (see FIG. 3).

The ROM 230 has stored therein a program and the like for the CPU 200 to function as the motion analyzing section 201 and the main control section 203 and perform various kinds of calculation processing and control processing. Besides, the ROM 230 may store various programs, data, and the like for realizing application functions.

The RAM 240 is used as a work area of the CPU 200 and temporarily stores, for example, a program and data read out from the ROM 230, data input from the operation section 220, and results of calculations executed by the motion analyzing section 201 according to various programs.

The recording medium 250 is a computer-readable medium for recording for storing various application programs and data. For example, an application program for causing a computer (PC) to function as the analysis control device 20 (a program used for the motion analysis system 1) may be stored in the recording medium 250. The recording medium 250 may function as a recording section configured to record data required to be stored for a long period among data generated by processing by the motion analyzing section 201. The recording medium 250 can be realized by, for example, an optical disk (a CD or a DVD), a magneto-optical disk (an MO), a magnetic disk, a hard disk, a magnetic tape, or a nonvolatile memory (an EEPROM, a flash memory, etc.).

The display section 260 displays a processing result of the motion analyzing section 201 as characters, a graph, or other images. The display section 260 is, for example, a CRT, an LCD, a touch panel display, or an HMD (head-mounted display). Note that the functions of the operation section 220 and the display section 260 may be realized by one touch panel display.

The CPU 200 functions as the motion analyzing section 201 and the main control section 203 according to the programs stored in the ROM 230 and the recording medium 250. The motion analyzing section 201 further includes the data acquiring section 202, the synchronization correction section 206, the first calculation section 207, the second calculation section 208, and the impact detecting section 209. Note that, in the motion analyzing section 201, a part or all of the components (the elements) may be omitted or new components (elements) may be added.

The data acquiring section 202 receives a plurality of measurement data received via the communication section 210. The acquired measurement data may be stored in, for example, the RAM 240.

The first measurement section 207 performs processing for calculating, for example, a sum (a norm) of the magnitudes of angular velocities around the axes on the basis of the measurement data acquired by the data acquiring section 202. The calculated sum (norm) corresponds to the first calculation value according to the invention. Note that, in the following explanation, a sum of the magnitudes of physical quantities (e.g., angular velocity and acceleration) included in the measurement data is represented as “norm”. Note that, when a physical quantity of one axis is measured, the “norm” means magnitude rather than a sum of magnitudes.

The second calculation section 208 performs processing for differentiating, with time, the norm calculated by the first calculation section 207. A calculated differential value corresponds to the second calculation value according to the invention (the value based on the first calculation value).

The impact detecting section 209 performs processing for detecting timing of an impact in a swing using the norm calculated by the first calculation section 207. The impact detecting section 209 may detect, as timing of an impact, for example, timing when a norm of angular velocities is the maximum. Alternatively, the impact detecting section 209 may detect, as the timing of the impact, earlier timing of timing when the value of the differential of the norm calculated by the second calculation section 208 is the maximum and timing when the value of the differential of the norm is the minimum. The impact detecting section 209 may detect, as the timing of the impact, timing when the value of the differential of the norm calculated by the second calculation section 208 is the maximal for the first time.

The synchronization correction section 206 synchronizes, on the basis of the timing of the impact calculated by the impact detecting section 209, a plurality of measurement data received by the data acquiring section 202. The motion analyzing section 201 accurately analyzes a motion of the measurement subject using the synchronized measurement data.

Note that, the main control section 203 is as explained with reference to FIG. 1.

Therefore, detailed explanation of the main control section 203 is omitted. After the motion of the measurement subject is analyzed, the main control section 203 performs processing for displaying, for example, a track of a swing on the display section 260.

Synchronization Method Between Measurement Data

FIG. 6 is a diagram in which the operations of the analysis control device 20 and the measuring units 10-1 and 10-2, which are the components of the motion analysis system 1, are arranged in time series. An interval of adjacent times among time t₁ to time tₙ₊₅ corresponds to a sampling cycle (e.g., 0.001 second) of the inertial sensors 111-1 and 111-2 included in the measuring units 10-1 and 10-2.

At time t₁, the analysis control device 20 instructs the measuring units 10-1 and 10-2 to start measurement. At time t₂, the measuring unit 10-1 is enabled to start measurement. At time t₄, the measuring unit 10-2 is enabled to start measurement.

The measuring units 10-1 and 10-2 are enabled to start measurement at different timings. This is because the analysis control device 20 transmits a measurement start command by unicast. That is, first, the analysis control device 20 designates the measuring unit 10-1 and instructs the measuring unit 10-1 to start measurement and then designates the measuring unit 10-2 and instructs the measuring unit 10-2 to start measurement.

If the motion analysis system 1 adopts a communication system in which broadcast and multicast can be used, the measuring units 10-1 and 10-2 can be enabled to start measurement at substantially the same timings. However, there is a problem in that, when the number of measuring units increases, consumption of bandwidth increases. That is, there is a problem in terms of extendability.

In the motion analysis system 1, if the measuring units 10-1 and 10-2 and the analysis control device 20 are connected by wire, the measuring units 10-1 and 10-2 can be enabled to start measurement at substantially the same timings. However, a degree of freedom of arrangement of the measuring units 10-1 and 10-2 decreases and a practical problem occurs.

In the motion analysis system 1, assuming that the analysis control device 20 transmits a measurement start command by unicast, it is also conceivable to adopt a method of instructing a measurement start at a fixed time interval T₀ and shifting measurement data by the time interval T₀ to synchronize the measurement data. However, it is also possible that a communication state by radio changes and the measurement start command is retransmitted to only one measuring unit. Therefore, a time interval for enabling the measuring units 10-1 and 10-2 to start measurement does not always coincide with T₀.

Therefore, the motion analyzing system 1 synchronizes the measurement data of the measuring units 10-1 and 10-2 using an impact that simultaneously affects the measurement data. In this example, it is assumed that, at time t₆, the user hits a ball with the club and an impact occurs.

At this point, the measuring units 10-1 and 10-2 have started measurement. A shock of the impact is recorded as measurement data. Portions marked by circles in FIG. 6 mean that measurement data of the measuring units 10-1 and 10-2 are generated. White circles indicate that an impact occurs. Black circles indicate that an impact does not occur.

Thereafter, the measuring units 10-1 and 10-2 continue the measurement for a while. At time tₙ₊₂, the analysis control device 20 instructs the measuring units 10-1 and 10-2 to stop the measurement. At time tₙ₊₃, the measuring unit 10-1 stops the measurement. At time tₙ₊₅, the measuring unit 10-2 stops the measurement.

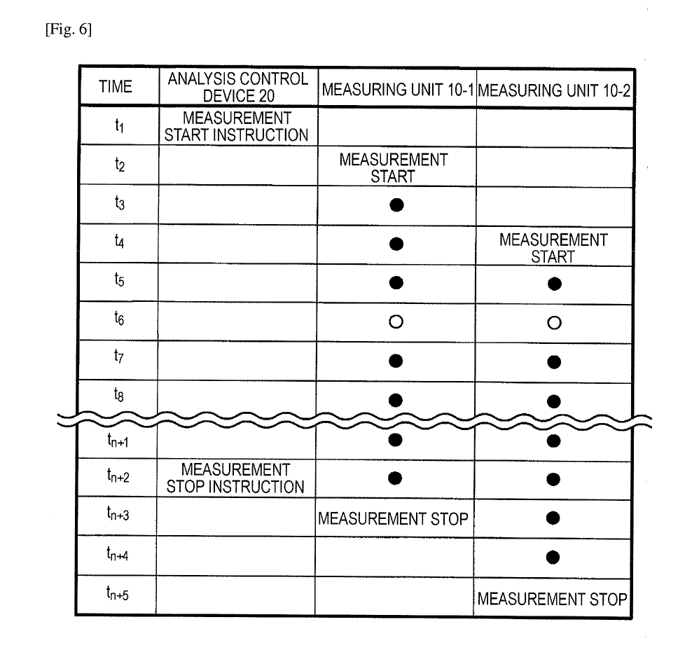

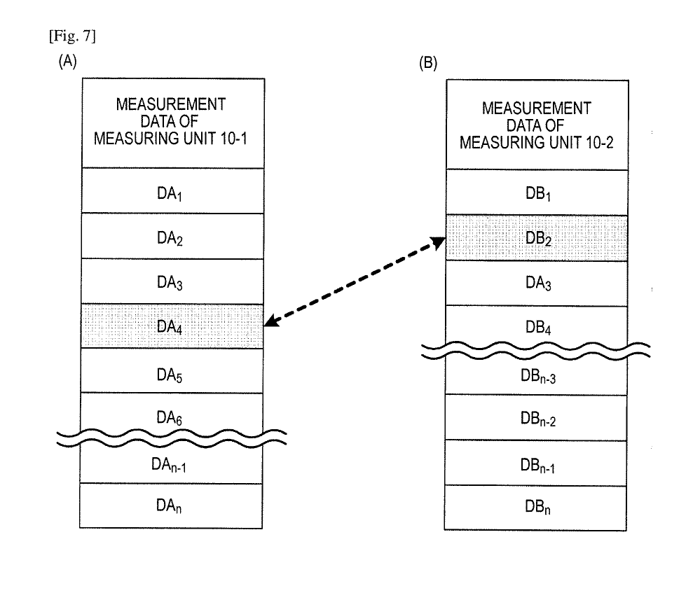

FIG. 7(A) shows measurement data of the measuring unit 10-1 at this point. FIG. 7(B) shows measurement data of the measuring unit 10-2 at this point. After the measurement stop instruction, the analysis control device 20 receives data shown in FIG. 7(A) and FIG. 7(B). However, since measurement start times and measurement stop times of the measuring unit 10-1 and the measuring unit 10-2 are different, the measurement data shown in FIG. 7(A) and FIG. 7(B) cannot be simply associated in the arranged order. It is necessary to synchronize the measurement data on the basis of timing of an impact. That is, the analysis control device 20 can accurately detect that timings of impacts shown in FIG. 7(A) and FIG. 7(B) are respectively measurement data DA₄ and DB₂ and synchronize the measurement data DA₄ and DB₂ by associating the measurement data DA₄ and DB₂.

Note that, in FIG. 7(A) and FIG. 7(B), the measurement data are simply represented as DAₙ and DBₙ. However, the respective data include all data from the acceleration sensors 112x, 112y, and 112z and the angular velocity sensors 113x, 113y, and 113z (see FIG. 4).

In order to accurately detect timing of an impact, it is necessary to perform calculation according to an appropriate procedure on the basis of measurement data. It is necessary to detect timing matching a characteristic of the impact. In the following explanation, with reference to flowcharts, overall processing of the motion analysis system 1 is explained and, at the same time, a rhythm detecting step for detecting timing of an impact is explained in detail.

### 2. Motion Analysis Method

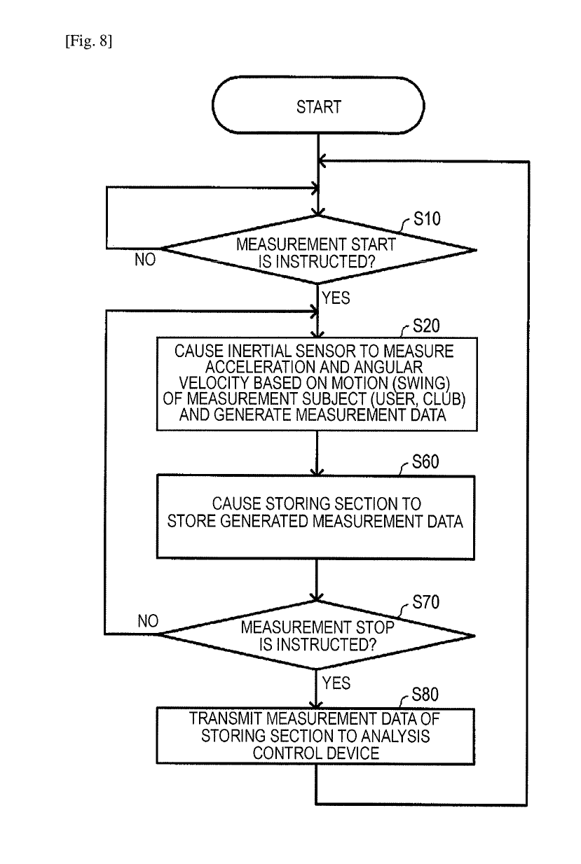

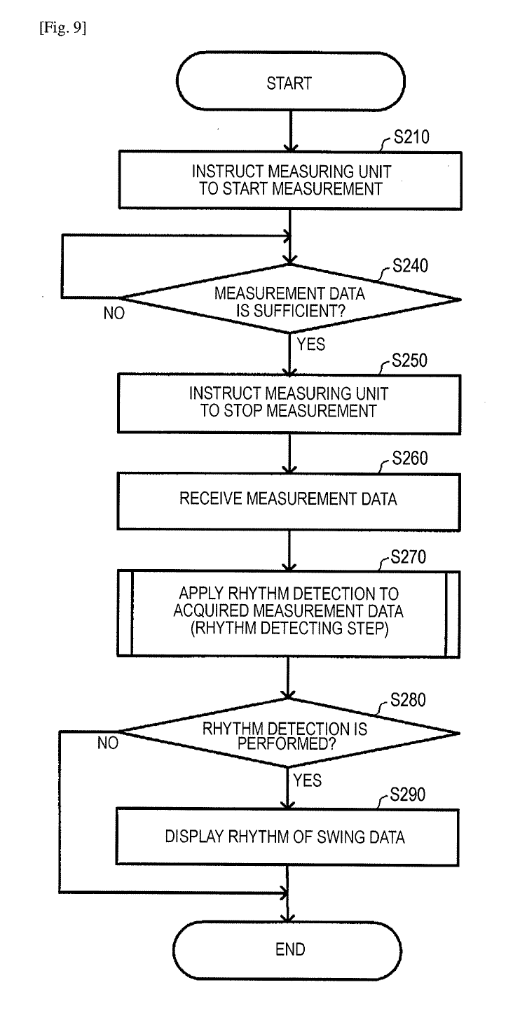

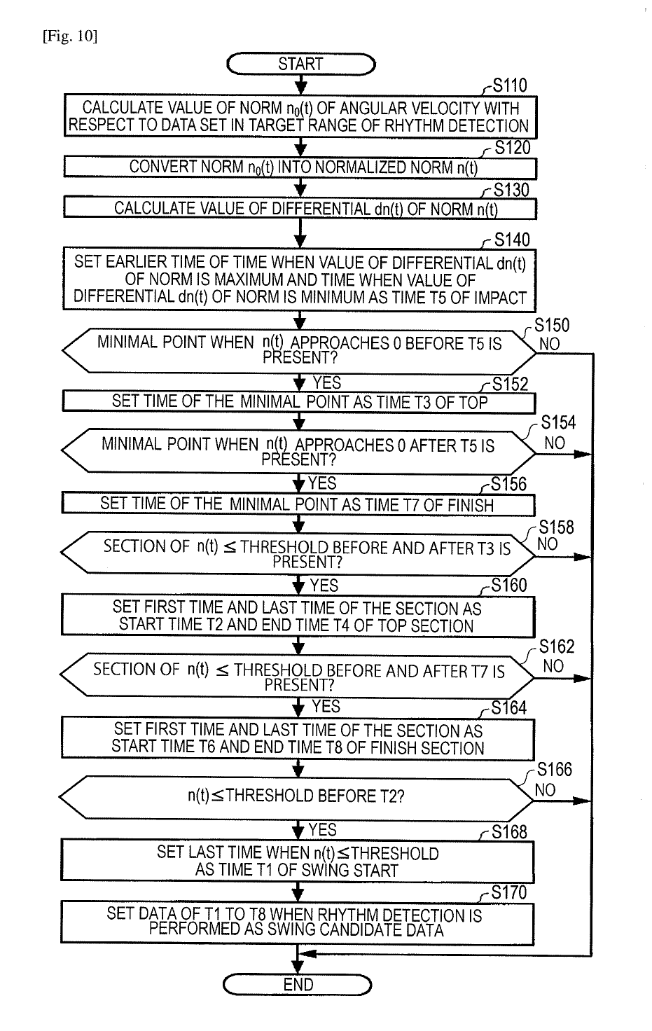

FIGS. 8 to 10 are flowcharts for explaining an example of a motion analysis method by the motion analysis system 1. FIG. 8 is a flowchart of processing by the measuring unit 10. FIGS. 9 to 10 are flowcharts of processing by the analysis control device 20. The control section 116 of the measuring unit 10 and the CPU 200 (the motion analyzing section 201 and the main control section 203) of the analysis control device 20 may execute these kinds of processing according to programs.

As shown in FIG. 8, the control section 116 of the measuring unit 10 stays on standby until a measurement start is instructed, that is, a measurement start command is received from the analysis control device 20 (N in S10). Upon receiving the measurement start command (Y in S10), the control section 116 causes the inertial sensor 111 to measure acceleration and angular velocity based on a motion of a measurement subject and generate measurement data (S20). The measurement subject is, for example, the user or the golf club (see FIG. 2) and the motion is, for example, a golf swing (see FIG. 3). The measurement data includes accelerations in the x-axis, y-axis, and z-axis directions measured by the acceleration sensors and angular velocities around the x axis, the y axis, and the z axis measured by the angular velocity sensors.

The control section 116 causes the storing section 115 to store the generated measurement data (S60). Thereafter, when a measurement stop is instructed, that is, when a measurement stop command is received from the analysis control device 20 (Y in S70), the control section 116 transmits the measurement data stored in the storing section 115 to the analysis control device 20 (S80). The control section 116 returns to step S10 and stays on standby until the next measurement start command is received from the analysis control device 20.

When the measurement stop is not instructed (N in S70), the control section 116 returns to step S20 and causes the inertial sensor 111 to measure acceleration and angular velocity based on the motion of the measurement subject and generate measurement data.

FIG. 9 shows processing by the CPU 200 of the analysis control device 20. First, the CPU 200 functions as the main control section 203. First, the main control section 203 instructs the measuring unit 10 to start measurement (S210). That is, the main control section 203 transmits a measurement start command to the measuring unit 10. The main control section 203 stays on standby until the measuring unit 10 obtains sufficient measurement data (N in S240). When the measuring unit 10 obtains sufficient measurement data (Y in S240), the control section 203 instructs the measuring unit 10 to stop the measurement (S250). That is, the main control section 203 transmits a measurement stop command to the measuring unit 10.

Thereafter, the CPU 200 functions as the motion analyzing section 201. When the data acquiring section 202 receives the measurement data from the measuring unit 10 (S260), the first calculation section 207, the second calculation section 208, and the impact detecting section 209 perform rhythm detection concerning the acquired measurement data (S270, a rhythm detecting step). Details of the rhythm detecting step are explained below. Note that rhythm means a series of actions from the start of a swing to the end of the swing. For example, in the case of a golf swing, the rhythm is equivalent to a series of actions from the start of a swing to a back swing, a top, a down swing, an impact, a follow-through, and the end of the swing.

When the rhythm detection is not performed (N in S280), the motion analyzing section 201 determines that data corresponding to the swing action (swing data) is not included in the acquired measurement data and ends the processing. In this case, the motion analyzing section 201 may display on the display section 260 that the swing data is not included in the acquired data.

On the other hand, when the rhythm detection is performed (Y in S280), the CPU 200 functions as the main control section 203, displays, for example, the swing data of the user on the display section 260 (S290), and ends the processing.

FIG. 10 is a flowchart for explaining the rhythm detecting step by the CPU 200 functioning as the first calculation section 207, the second calculation section 208, and the impact detecting section 209.

As shown in FIG. 10, first, the CPU 200 functions as the first calculation section 207 and calculates a value of a norm n₀(t) of angular velocities at times t from acquired measurement data (S110). As an example of a method of calculating a norm of angular velocities (a sum of the magnitudes of angular velocities), there is a method of calculating the norm from “a root of a sum of squares of the magnitudes of angular velocities”. For example, when the angular velocity sensors 113x, 113y, and 113z detect angular velocities around three axes and data for the three axes at times t of a data acquisition period are represented as x(t), y(t), and z(t), the norm n₀(t) of the angular velocities is calculated according to the following Expression (1).

[Math.1]

n₀(t)=\sqrt{x(t)²+y(t)²+z(t)²} (1)

Subsequently, the CPU 200 converts the norm n₀(t) of the angular velocities at times t into a norm n(t) normalized to a predetermined range (S120). Specifically, when a maximum of a norm of angular velocities in the data acquisition period is represented as max(n₀), according to the following Expression (2), the norm n₀(t) of the angular velocities is converted into the norm n(t) normalized to a range of 0 to 1.00.

$$[ Math . 2 ]$$

$$n ( t ) = \frac{100 \times {n}_{0} ( t )}{max ( {n}_{0} )} \qquad ( 2 )$$

Subsequently, the CPU 200 functions as the second calculation section 208 and calculates a value of differential dn(t) of the norm (the norm after normalization) n(t) at times t (S130). For example, when an acquisition interval of data of angular velocity is represented as delta_t, the differential (a difference) dn(t) of a norm of angular velocities at times t is calculated according to the following Expression (3).

[Math.3]

dn(t)=n(t)−n(t−delta_{—}t) (3)

Note that, in this embodiment, the norm n₀(t) is defined as indicated by Expression (1). However, the following Expression (4) may be used.

[Math.4]

n₀(t)=|x(t)|+|y(t)|+|z(t)| (4)

The following Expression (5) may be used rather than Expression (1) and Expression (4).

[Math.5]

n₀(t)=|x(t)+y(t)+z(t)| (5)

In this embodiment, a norm is calculated concerning angular velocities included in measurement data. However, a norm may be calculated concerning accelerations. In this case, the definitions of the norm n₀(t), the norm n(t), and the differential dn(t) of the norm are the same as the definitions explained above.

Subsequently, the CPU 200 functions as the impact detecting section 209 and sets, as time T5 of an impact, earlier time of time when a value of the differential dn(t) of the norm is the maximum and time when the value of the differential dn(t) of the norm is the minimum (S140).

In a normal golf swing, swing speed is considered to the maximum at an instance of an impact. A value of a norm of angular velocities is considered to change according to the swing speed. Therefore, timing when a differential value of the norm of the angular velocities is the maximum or the minimum in a series of swing actions (i.e., timing when the differential value of the norm of the angular velocities is a positive maximum or a negative minimum) can be grasped as timing of the impact. Note that, since the golf club is vibrated by the impact, timing when the differential value of the norm of the angular velocities is the maximum and timing when the differential value of the norm of the angular velocities is the minimum are considered to occur as a pair. However, earlier timing of the timings is considered to be the instance of the impact.

The CPU 200 of the analysis control device 20 can accurately detect the impact by detecting, as timing of the impact, earlier timing of timing when the differential value of the norm of the angular velocities is the maximum and timing when the differential value of the norm of the angular velocities is the minimum and synchronize the measurement data on the basis of the timing of the impact. That is, the CPU 200 can function as the synchronization correction section 206 and synchronize the measurement data at appropriate timing after the impact detection. The CPU 200 performs processing explained below in order to analyze a track of a swing (see FIG. 3) after the impact detection as well.

The CPU 200 determines whether a minimal point when a value of the norm n(t) approaches 0 before time T5 of the impact is present (S150). If the minimal point is present (Y in S150), the CPU 200 sets time of the minimal point as time T3 of a top (S152). In the normal golf swing, after the swing is started, the action stops once at the top. Therefore, timing when the norm of the angular velocities approaches 0 to be the minimal before the timing of the impact can be grasped as timing of the top.

Subsequently, the CPU 200 determines whether a minimal point when the value of the norm n(t) approaches 0 after time T5 of the impact is present (S154). If the minimal point is present (Y in S154), the CPU 200 sets time of the minimal point as time T7 of a finish (S156). In the normal golf swing, it is considered that, after the impact, swing speed gradually decreases and the golf swing stops. Therefore, timing when the norm of the angular velocities approaches 0 to be the minimal after the timing of the impact can be grasped as timing of the finish.

The CPU 200 determines whether a section where the value of the norm n(t) is equal to or smaller than a threshold set in advance before and after time T3 of the top is present (S158). If the section is present (Y in S158), the CPU 200 sets first and last times of the section respectively as start time T2 and end time T4 of a top section (S160). In the normal golf swing, since the action stops once at the top, the swing speed is considered to be small before and after the top. Therefore, a continuous section where the timing of the top is included and the norm of the angular velocities is equal to or smaller than a given threshold can be grasped as the top section.

The CPU 200 determines whether a section where the value of the norm n(t) is equal to or smaller than the threshold set in advance before and after time T7 of the finish is present (S162). If the section is present (Y in S162), the CPU 200 sets first time and last time of the section respectively as start time T6 and end time T8 of a finish section (S164). In the normal golf swing, it is considered that, after the impact, swing speed gradually decreases and the golf swing stops. Therefore, a continuous section where the timing of the finish is included and the norm of the angular velocities is equal to or smaller than the given threshold can be grasped as the finish section.

Subsequently, the CPU 200 determines whether the value of the norm n(t) is equal to or smaller than the threshold set in advance before start time T2 of the top section (S166). If the value of the norm n(t) is equal to or smaller than the threshold (Y in S166), the CPU 200 sets, as time T1 of a swing start, last time when the value of the norm n(t) is equal to or smaller than the threshold (S168). Note that a minimal point when the norm approaches 0 before the minimal point specifying the top may be regarded as the swing start. In the normal golf swing, it is hard to consider that a swing action is started from a stationary state and the swing action stops before the top. Therefore, last timing when the norm of the angular velocities is equal to or smaller than the threshold before the timing of the top can be grasped as timing of the start of the swing action.

The CPU 200 sets data of T1 to T8 when the rhythm detection is performed as swing data (S170) and ends the processing.

On the other hand, when the minimal point when the value of the norm n(t) approaches 0 before time T5 of the impact is absent (N in S150), when the minimal point when the value of the norm n(t) approaches 0 after time T5 of the impact is absent (N in S154), when the section where the value of the norm n(t) is equal to or smaller than the threshold before and after time T3 of the top is absent (N in S158), when the section where the value of the norm n(t) is equal to or smaller than the threshold before and after time T7 of the finish is absent (N in S162), and when the value of the norm n(t) is not equal to or smaller than the threshold before the start time T2 of the top section (N in S166), the CPU 200 determines that the CPU 200 fails in the rhythm detection for the acquired data (swing data is not included in the acquired data) and ends the processing.

In the flowchart of FIG. 10, the step (S130) for calculating a value of the differential dn(t) of the norm (the norm after normalization) n(t) at times t can be omitted. In particular, the differential step (S130) can be omitted for a swing with a large change of a norm of angular velocities such as a swing of a driver. When step S130 is omitted, the maximum of the norm of the angular velocities calculated in S120 only has to be detected as the timing of the impact.

In the flowchart of FIG. 10, all the actions from the start of the swing to the back swing, the top, the down swing, the impact, the follow-through, and the end of the swing are detected. However, at least one action of the swing actions may be detected, for example, the actions of only the impact and the down swing may be detected. The steps of the flowchart of FIG. 10 can be interchanged as appropriate.

### 3. Test Example

FIG. 11A is a diagram in which three-axis angular velocities x(t), y(t), and z(t) are represented as a graph from data acquired in a data acquisition period (five seconds) at the time when a test subject holds and full-swings a driver. In FIG. 11A, the abscissa indicates time (msec) and the ordinate indicates angular velocity (dps).

FIG. 11B is a diagram in which the norm n(t) obtained by calculating the norm n₀(t) of three-axis angular velocities from the three-axis angular velocities x(t), y(t), and z(t) shown in FIG. 11A according to Expression (1) and then scale-converting (normalizing) the norm n₀(t) into 0 to 100 according to Expression (2) is represented as a graph. In FIG. 11B, the abscissa indicates time (msec) and the ordinate indicates a norm of angular velocities (scale-converted into 0 to 100).

FIG. 11C is a diagram in which the differential dn(t) of the norm n(t) of the three-axis angular velocities shown in FIG. 11B is calculated from the norm n(t) of the three-axis angular velocities according to Expression (3) and represented as a graph. In FIG. 11C, the abscissa indicates time (msec) and the ordinate indicates a differential value of a norm of three-axis angular velocities. Note that, in FIGS. 11A and 11B, the abscissa is displayed in the scale of 0 to 5 seconds. However, in FIG. 11C, the abscissa is displayed in the scale of 2 seconds to 2.8 seconds to clearly show a change in the differential value before and after an impact.

From FIGS. 11B and 11C, according to the flowchart of the rhythm detection processing shown in FIG. 10, time T1 of the swing start, start time T2 of the top section, time T3 of the top, end time T4 of the top section, time T5 of the impact, start time T6 of the finish section, time T7 of the finish, and end time T8 of the finish section are calculated.

As a result, T1=1000 msec, T2=1967 msec, T3=2024 msec, T4=2087 msec, T5=2397 msec, T6=3002 msec, T7=3075 msec, and T8=3210 msec are obtained. In this way, concerning a strong swing action such as the full swing, the time T5 of the impact and detailed data of rhythm are obtained.

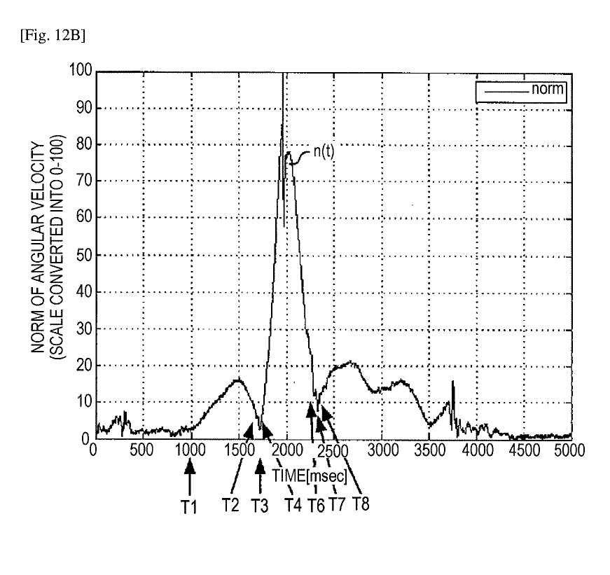

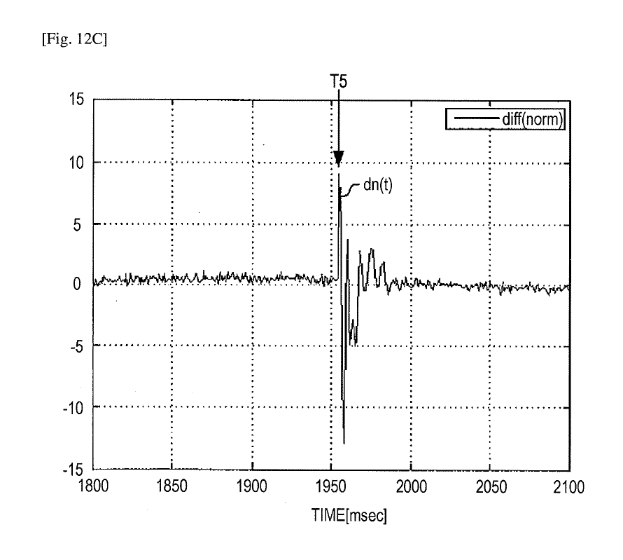

On the other hand, FIG. 12A is a diagram in which three-axis angular velocities x(t), y(t), and z(t) are represented as a graph from data acquired in a data acquisition period (five seconds) at the time when the test subject holds a putter and performs putting. In FIG. 12A, the abscissa indicates time (msec) and the ordinate indicates angular velocity (dps).

FIG. 12B is a diagram in which the norm n(t) obtained by calculating the norm n₀(t) of three-axis angular velocities from the three-axis angular velocities x(t), y(t), and z(t) shown in FIG. 12A according to Expression (1) and then scale-converting (normalizing) the norm n₀(t) into 0 to 100 according to Expression (2) is represented as a graph. In FIG. 12B, the abscissa indicates time (msec) and the ordinate indicates a norm of angular velocities (scale-converted into 0 to 100).

FIG. 12C is a diagram in which the differential dn(t) of the norm n(t) of the three-axis angular velocities shown in FIG. 12B is calculated from the norm n(t) of the three-axis angular velocities according to Expression (3) and represented as a graph. In FIG. 12C, the abscissa indicates time (msec) and the ordinate indicates a differential value of a norm of three-axis angular velocities.

From FIGS. 12B and 12C, according to the flowchart of the rhythm detection processing shown in FIG. 10, time T1 of the swing start, start time T2 of the top section, time T3 of the top, end time T4 of the top section, time T5 of the impact, start time T6 of the finish section, time T7 of the finish, and end time T8 of the finish section are calculated.

As a result, T1=1000 msec, T2=1680 msec, T3=1736 msec, T4=1770 msec, T5=1953 msec, T6=2302 msec, T7=2349 msec, and T8=2405 msec are obtained. In this way, concerning a weak swing action such as the putting, the time T5 of the impact and detailed data of rhythm are obtained.

Note that, in examples shown in FIGS. 11A to 11C and FIGS. 12A to 12C, as explained above, the step (S130) for calculating a value of the differential dn(t) of the norm (the norm after normalization) n(t) at times t can be omitted. In particular, the differential step (S130) can be omitted for a swing with a large change of a norm of angular velocities such as the swing of the driver in FIGS. 11A to 11C. When the differential step is omitted, the maximum of the norm of the angular velocities calculated in S120 (FIGS. 11B and 12B) only has to be detected as the timing of the impact.

### 4. Other Impact Detecting Methods

In the impact detecting method (S140 in FIG. 10), a norm is calculated concerning angular velocities. On the other hand, since not only angular velocity but also acceleration is included in the measurement data in this embodiment, it is preferable that there is a detecting method of impact timing adapted to both the angular velocity and the acceleration. In this case, for example, it is possible to verify timing of an impact detected according to the angular velocity with timing of an impact detected according to the acceleration.

As shown in FIG. 2, the two measuring units 10-1 and 10-2 are used in this embodiment. It is preferable that there is a detecting method for impact timing adapted to both of the measuring unit 10-1 attached to the club and the measuring unit 10-2 attached to the arm. In this case, it is also possible to use one for verification of the other.

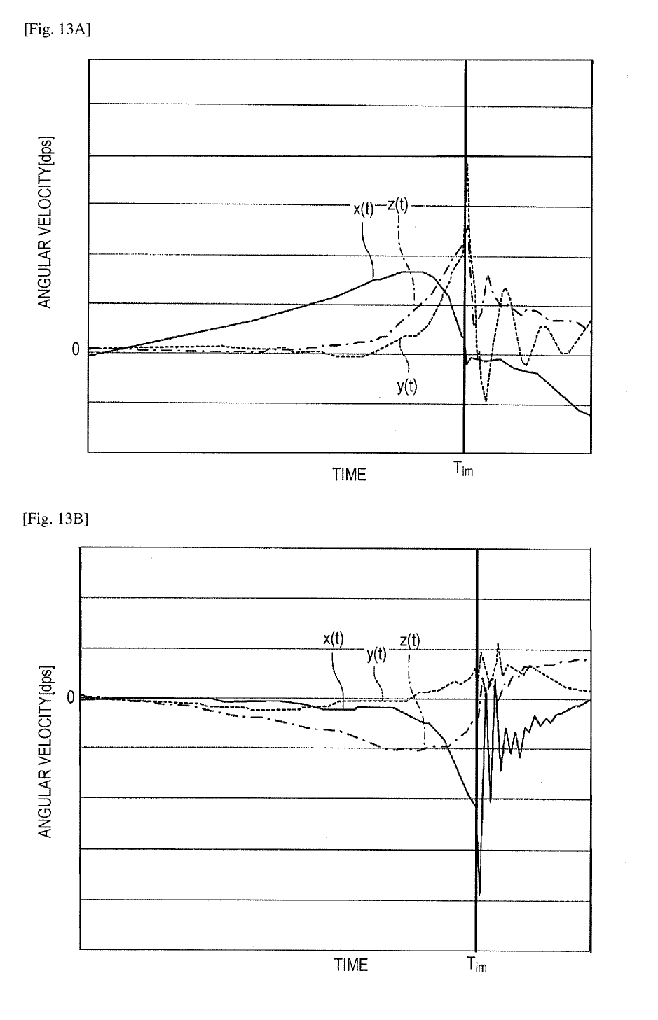

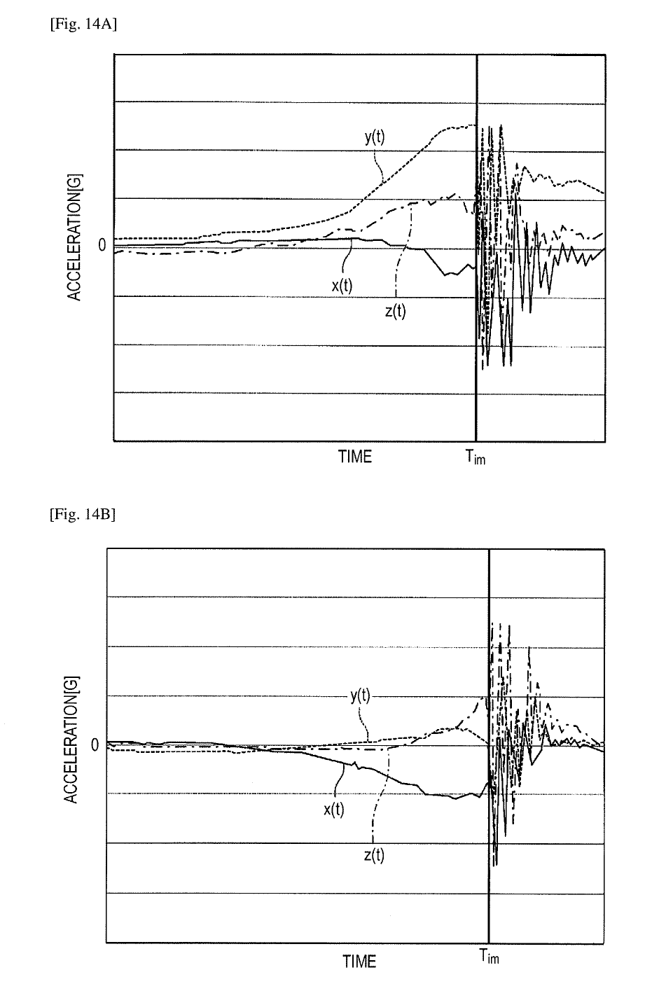

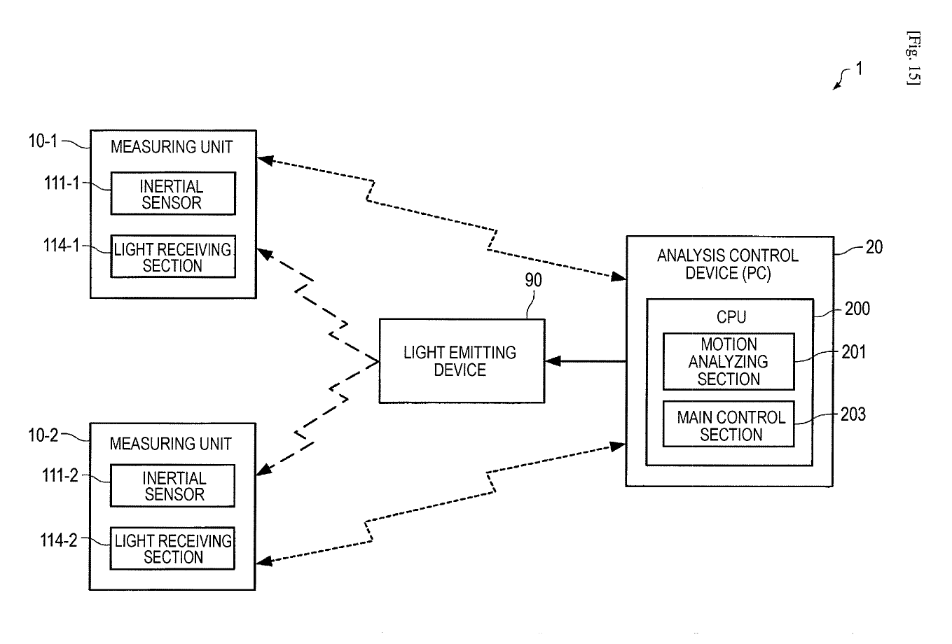

Therefore, a test was performed and changes with time of measurement data of the measuring units 10-1 and 10-2 and timing of an impact were displayed one on top of the other. FIGS. 13A and 13B are respectively diagrams showing changes with time of angular velocity data of the measuring units 10-1 and 10-2 and timing Tᵢₘ of an actual impact. FIGS. 14A and 14B are diagrams respectively showing changes with time of acceleration data of the measuring units 10-1 and 10-1 and timing Tᵢₘ of an actual impact.

When examined from results of FIGS. 13A and 13B, time when a change amount of the magnitude of an angular velocity vector is maximal for the first time can be set as timing of the impact. This applies to both of the measuring unit 10-1 and the measuring unit 10-2.

When examined from results of FIGS. 14A and 14B, time when a change amount of the magnitude of an acceleration vector is maximal for the first time can be set as timing of the impact. This applies to both of the measuring unit 10-1 and the measuring unit 10-2.

That is, irrespective of angular velocity or acceleration and irrespective of an attaching part, time when a change amount of the magnitude of measured data is maximal for the first time can be set as timing of the impact. Further, timing of the impact was able to be calculated by this method not only for the three axes (the x axis, the y axis, and the z axis) but also for, for example, one axis (e.g., only the x axis) other than the three axes.

Therefore, in this embodiment, for example, instead of step S140 in FIG. 10, time when a norm is maximal for the first time in angular velocity or acceleration of measurement data from either of the measuring units 10 can also be set as timing of the impact (time T5).

As explained above, in the motion analysis system 1, the motion analysis method, and the like in this embodiment, it is possible to increase a degree of freedom of an attaching position of the measuring unit 10 for communicating with the analysis control device 20 by radio. The analysis control device 20 can execute an accurate motion analysis by synchronizing measurement data from the plurality of measuring units 10 on the basis of information for synchronization.

In the motion analysis system 1 in this embodiment, since a peculiar information generating section for synchronization such as the light emitting device 90 is unnecessary, it is possible to suppress costs. The user does not need to perform an action unrelated to a swing such as a jump. Therefore, it is possible to realize the motion analysis system 1 having high convenience of use.

The invention is not limited to the examples explained above. The invention includes a configuration substantially the same as the configuration explained in the embodiment (e.g., a configuration in which a function, a method, and a result are the same or a configuration in which an object and an effect are the same). The invention includes a configuration in which unessential portions of the configuration explained in the embodiment are replaced. The invention includes a configuration that realizes action and effects the same as the action and effects of the configuration explained in the embodiment or a configuration that attains an object the same as the object of the configuration explained in the embodiment. The invention includes a configuration in which a publicly-known technique is added to the configuration explained in the embodiment.

In particular, in the embodiment and the like explained above, the motion analysis system 1 is explained with reference to the analysis of the golf swing as an example. However, the motion analysis system 1 can be applied to analyses of motions performed using various exercise instruments used for swings such as a tennis racket and a bat of baseball.

### REFERENCE SIGNS LIST

1 Motion analysis system
10 Measuring unit
10-1 Measuring unit
10-2 Measuring unit
20 Analysis control device (PC)
30 Golf club
90 Light emitting device
100 Motion analysis system
111 Inertial sensor
111-1 Inertial sensor
111-2 Inertial sensor
112x Acceleration sensor
112y Acceleration sensor
112z Acceleration sensor
113x Angular velocity sensor
113y Angular velocity sensor
113z angular velocity sensor
114-1 Light receiving section
114-2 Light receiving section
115 Storing section
116 Control section
118 Communication section
200 CPU
201 Motion analyzing section
202 Data acquiring section
203 Main control section
206 Synchronization correction section
207 First calculation section
208 Second calculation section
209 Impact detecting section
210 Communication section
220 Operation section
230 ROM
240 RAM
250 Recording medium
260 Display section
A Swing track
P1 Swing start position
P2 Top position
P3 Impact position
P4 Follow-through top position

1. A motion analysis system comprising:
a plurality of measuring units; and
an analysis control device,
wherein the analysis control device receives measurement data of physical quantities based on a motion of a measurement subject from the plurality of measuring units,
determines, for each of the measuring units, timing of an impact in the motion using the measurement data, and synchronizes the measurement data using the timing of the impact.

2. The motion analysis system according to claim 1, wherein the measuring unit includes an angular velocity sensor for detecting angular velocities generated around a plurality of axes, and
the analysis control device calculates, as a first calculation value, a sum of magnitudes of the angular velocities generated in the axes and determines the timing of the impact using the first calculation value.

3. The motion analysis system according to claim 2, wherein the analysis control device determines, as the timing of the impact, timing when the first calculation value is the maximum.

4. The motion analysis system according to claim 2, wherein the analysis control device differentiates the first calculation value to calculate a second calculation value and detects, as the timing of the impact, earlier timing of timing when the second calculation value is maximum and timing when the second calculation value is minimum.

5. The motion analysis system according to claim 1, wherein the measuring unit includes an acceleration sensor for detecting accelerations generated in a plurality of axial directions, and
the analysis control device calculates, as a first calculation value, a sum of magnitudes of the accelerations generated in the axes.

6. The motion analysis system according to claim 5, wherein the analysis control device differentiates the first calculation value to calculate a second calculation value and determines, as the timing of the impact, timing when the second calculation value is the maximal for the first time.

7. A motion analysis method comprising:
receiving measurement data of physical quantities based on a motion of a measurement subject from each of a plurality of measuring units;
determining, as timing of an impact in the motion, time when the measurement data satisfies a determination condition; and
synchronizing the measurement data using the timing of the impact.
